(19) United States
(12) Patent Application Publication
(10) Pub. No.: US 2009/0240553 A1
(43) Pub. Date: Sep. 24, 2009

(54) Workflow management system

(75) Inventor: Hideo Sato, Kanagawa (JP)

Correspondence Address: HARNESS, DICKEY & PIERCE, P.L.C., P.O. BOX 8910, RESTON, VA, 20195, US

(73) Assignee: RICOH COMPANY, LTD.

(21) Appl. No.: 12/382,468

(22) Filed: Mar. 17, 2009

(30) Foreign Application Priority Data
Mar. 18, 2008 (JP) 2008-070375

(51) Int. Cl. G06Q 10/00

(52) U.S. Cl. 705/9

(57) ABSTRACT

A workflow management system for dynamically structuring a workflow model when executing a workflow is disclosed. Task information including at least a task name and detailed information is acquired from a working task when a search request of a human resource or a task is made, skill profile information including at least a skill name is input when the search request is made, a similar existing task is searched for based on the task information, related person information of a searched task is acquired, a consistency is checked with the skill profile information with respect to the searched related person information, the human resource having the skill indicated in the skill profile information is searched for, ranking points for each human resource or each task are calculated based on outputs of the check part and the skill search part, and the ranking points prioritized by higher points are presented.

### BACKGROUND OF THE INVENTION

1. Field of the Invention

The present invention is related to a workflow management system, and more particularly to the workflow management system for dynamically configuring a workflow model when executing the workflow.

2. Description of the Related Art

In order to individually create tasks (including subtasks) forming a workflow, it is required to search for a proper person to delegate a task which is to be appropriately executed, to search for a proper person which is a proper as an actual member who conducts works on a task, and to search for a proper person who can appropriately consult. Thus, it is desired to easily find out a proper human resource. Japanese Laid-open Patent Applications No. 2004-118648, No. 2001-338097, No. 2006-244000, and No. 2005-327028 disclose technologies for managing human resources by considering their skills.

In addition, to individually create the task forming the workflow, it is required to easily find out a similar foregone task to reuse and review. In this case, in a viewpoint in which not only a description of a title (task name) and detailed information of the task are similar to the foregone task but also the foregone task is reused and is used as reference information, it is desired to present existing tasks being widely meaningful as candidates.

However, the above-described conventional workflow management system are not fully arranged for functions in searching for the proper human resources and for searching for meaningful tasks to reuse and use as the reference information, and do not correspond to users' requirements.

### SUMMARY OF THE INVENTION

The present invention solves or reduces one or more of the above problems.

In an aspect of this disclosure, there is provided a workflow management system for dynamically structuring a workflow model when executing a workflow, including: a task information acquisition part configured to acquire task information including at least a task name and detailed information from a working task when a search request of a human resource or a task is made; a skill profile information input part configured to input skill profile information including at least a skill name when the search request is made; a similar task search part configured to search for a similar existing task based on the task information; a related person acquisition part configured to acquire related person information of a task searched by the similar task search part; a check part configured to check a consistency with the skill profile information with respect to the related person information searched by the related person acquisition part; a skill search part configured to search for the human resource having the skill indicated in the skill profile information; and an integration part configured to calculate ranking points for each human resource or each task based on outputs of the check part and the skill search part, and to present the ranking point prioritized by higher points.

In other aspects of this disclosure, there may be provided a workflow management method conducted in a workflow management system for dynamically structuring a workflow model when executing a workflow, and a program product for causing a computer to function as a workflow management system for dynamically structuring a workflow model when executing a workflow.

### BRIEF DESCRIPTION OF THE DRAWINGS

In the following, embodiments of the present invention will be described with reference to the accompanying drawings.

FIG. 1 is a diagram illustrating a configuration example of a workflow management system according to an embodiment of the present invention;

FIG. 2 is a diagram illustrating an implementation example of the workflow management system;

FIG. 3 is a diagram illustrating a configuration example of a workflow;

FIG. 4 is a diagram illustrating a data structure example of a task instance DB;

FIG. 5 is a diagram illustrating a data structure example of a skill information DB;

FIG. 6 is a sequence diagram illustrating a process example according to the embodiment;

FIG. 7 is a diagram illustrating an example of a search screen;

FIG. 8 is a diagram illustrating information (data) and a process flow when a search is conducted, according to the embodiment; and

FIG. 9 is a diagram illustrating an example of an integration result.

### DESCRIPTION OF THE PREFERRED EMBODIMENT

In the following, an embodiment of the present invention to will be described with reference to the accompanying drawings.

### <System Configuration>

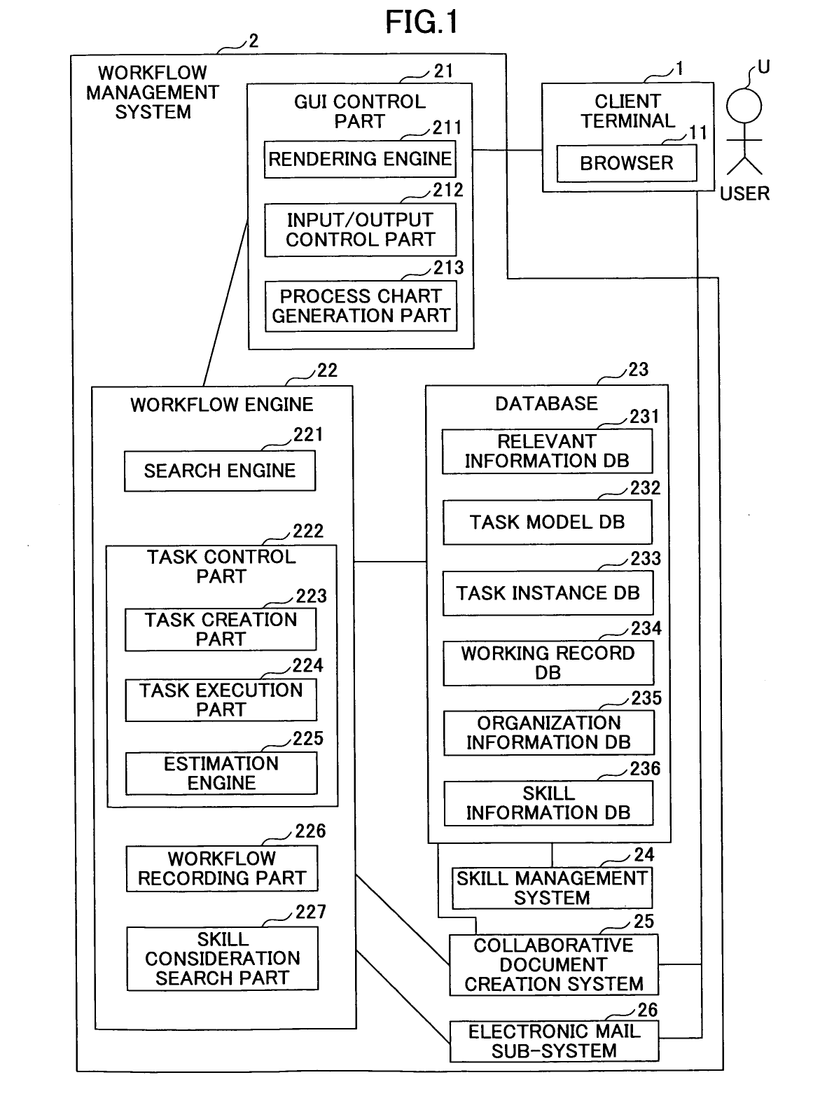

FIG. 1 is a diagram illustrating a configuration example of a workflow management system according to an embodiment of the present invention.

In FIG. 1, a workflow management system 2 includes a GUI control part 21 for presenting a GUI (Graphical User Interface) to a client terminal 1 with respect to an access of a browser 11 of the client terminal 1 such as a PC (Personal Computer) or a like which is operated by a user U using the workflow management system 2, a workflow engine 22 for dynamically generating and conducting a workflow model by reusing either one or both of an existing task model and a task instance, a database 23 for retaining information necessary to a process, a skill management system 24 for managing skill information of the human resources which is assigned to the tasks forming the workflow, a collaborative document creation system 25 formed by a CMS (Contents Management System) of WiKi or a like, and an electronic mail sub-system 26 including functions of sending and receiving an electronic mail (hereinafter, called e-mail).

The database 23 includes a relevant information DB 231 for storing relevant information referred to when the workflow is conducted, a task model DB 232 for storing a task model which is made to be an abstraction by an administrator beforehand, a task instance DB 233 for storing task instances which were actually used or have been used currently in the workflow, a working record DB 234 for storing a working record of the workflow, an organization information DB 235 for storing information of a user and information of a user group to which the user belongs, and a skill information DB 236 for storing skill information of human resources. The task model DB 232 and the task instance DB 233 include links to information registered to the relevant information DB 231.

The GUI control part 21 includes a rendering engine 211 for drawing a display screen image, an input/output control part 212 for exchanging information with the user U, and a process chart generation part 213 for generating a process chart in which the workflow is visualized.

The workflow engine 22 includes a search engine 221 for conducting various searches with respect to the database 23, a task control part 222 for controlling the tasks forming the workflow, a workflow recording part 226 for monitoring operations of the user U and the workflow management system 2 and recording the working record of the workflow to the working record DB 234, and a skill consideration search part 227 for searching for an expert (person) or a task in which a skill has been considered and for presenting a result to the user U. The skill consideration search part 227 uses a function of the search engine 221 when searching in the database 23.

The task control part 222 includes a task creation part 223 for creating a task, a task execution part 224 for executing a created task, and an estimation engine 225 for estimating a current task of the user U based on information of the working record DB 234 and searching for relative information in the database 23.

The workflow management system 2 realizes a dynamic definition (constructive workflow) of the workflow by enabling a combination of workflow components (typical workflow portions) determined beforehand. In a research and development field, a service business field, and a like in which a perfectibility of prior information is lower, it is difficult to formulate a proactive workflow model. However, by dynamically configuring a model when executing the workflow, it becomes a flexible and responsive system.

In addition, it becomes possible to create a workflow in a WBS (Work Breakdown Structure) and to easily delegate a task. Moreover, it includes a function for timely presenting information necessary for a user who executes the task.

As a basic operation overview of a workflow control, the user U creates and executes the workflow, creates the workflow model, registers relevant information and a document, and conducts a process to link them to a workflow instance and to the workflow model by operating the workflow engine 22 through the input/output control part 212 of the GUI control part 21.

In creating the workflow, the search engine 221 of the workflow engine 22 conducts various searches with respect to the database 23.

The task control part 222 of the workflow engine 22 uses the task model DB 232 and the task instance DB 233, and controls the task based on an instruction of the user U and a like. The task creation part 223 of the task control part 222 creates the task based on information of the database 23 in accordance with the instruction of the user U, and conducts a process to link information. The task execution part 224 uses information of the task instance DB 233 in accordance with the instruction of the user, and updates actual task information. An execution of the task means an update of the task information in the workflow management system 2. The estimation engine 225 estimates a current task of the user U based on the information of the working record DB 234, and searches for information relevant to the current task in the database 23.

The workflow recording part 226 monitors the operation of the user U and the operation of the workflow management system 2, and stores the working record of the workflow to the working record DB 234.

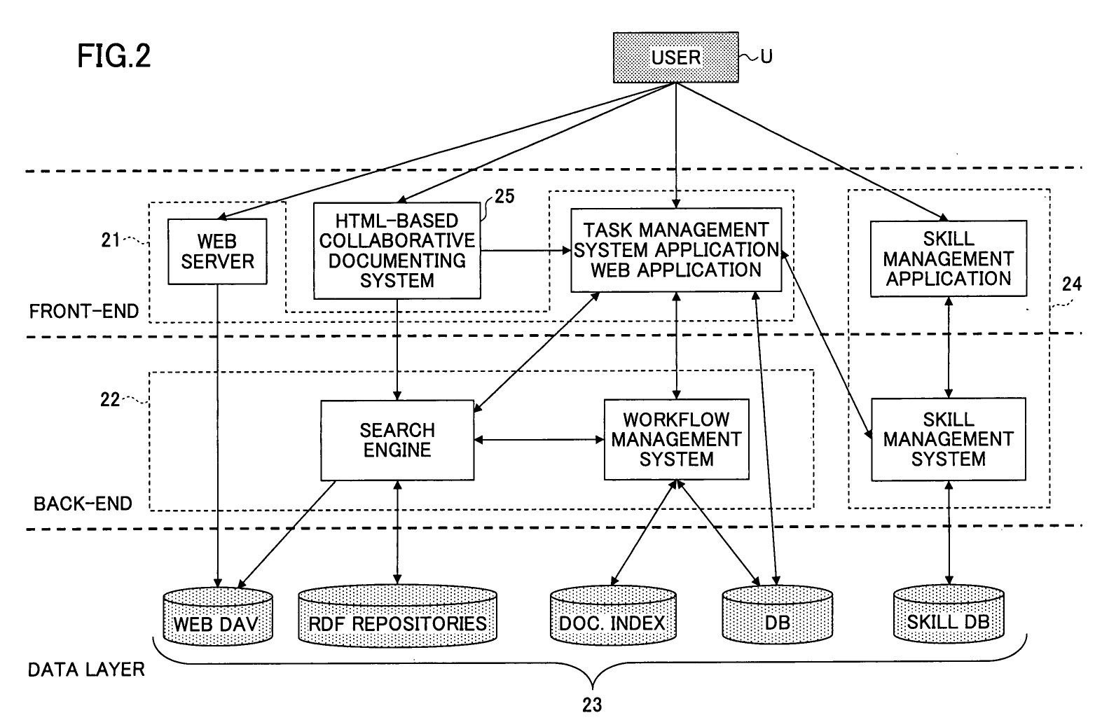

FIG. 2 is a diagram illustrating an implementation example of the workflow management system 2. A “WEB SERVER” and a “TASK MANAGEMENT SYSTEM APPLICATION WEB APPLICATION” correspond to the GUI control part 21, an “HTML-BASED COLLABORATIVE DOCUMENTING SYSTEM” corresponds the collaborative document creation system 25, and a “SKILL MANAGEMENT APPLICATION” and a “SKILL MANAGEMENT SYSTEM” correspond to the skill management system 24. Also, the “WEB SERVER”, “HTML-BASED COLLABORATIVE DOCUMENTING SYSTEM”, “TASK MANAGEMENT SYSTEM APPLICATION WEB APPLICATION”, and “SKILL MANAGEMENT APPLICATION” configures a frontend. That is, the collaborative document creation system 25 is configured on a basis of a Web server and an HTML (HyperText Markup Language), so that the user U can access the workflow management system 2 by using the Web browser (browser 11). In addition, since it is assumed that the user U accesses the system 2 by using the browser 11 in this embodiment, a function is required to control an access which is conducted to files through a network. In this embodiment, this function is realized by using a file management system on the network such as NetDrive or a like.

Moreover, a “WORKFLOW MANAGEMENT SYSTEM” and a “SEARCH ENGINE” correspond to the workflow engine 22, and configure a backend with the “SKILL MANAGEMENT SYSTEM” which is a part of the skill management system 24. A well-known basic function of the workflow management can be applied as an engine of the workflow management system 2. Also, as a search engine to search for a task and the relevant information, a search engine using general queries can be used.

Furthermore, a “WEBDAV”, a “RDF REPOSITORIES”, a “DOC.INDEX”, a “DB”, and a “SKILL DB” correspond to the database 23, and form a data layer. Task information and the relevant information are managed as an RDF (Resource Description Framework) repository, and the relevant information and the like are managed by a document repository and an index server. The former correspond to the task model Db 232 and the task instance DB 233, and the latter corresponds to the relevant information DB 231. User information and organization information can be also realized by using the RDF repository, and correspond to the organization information DB 235 in FIG. 1.

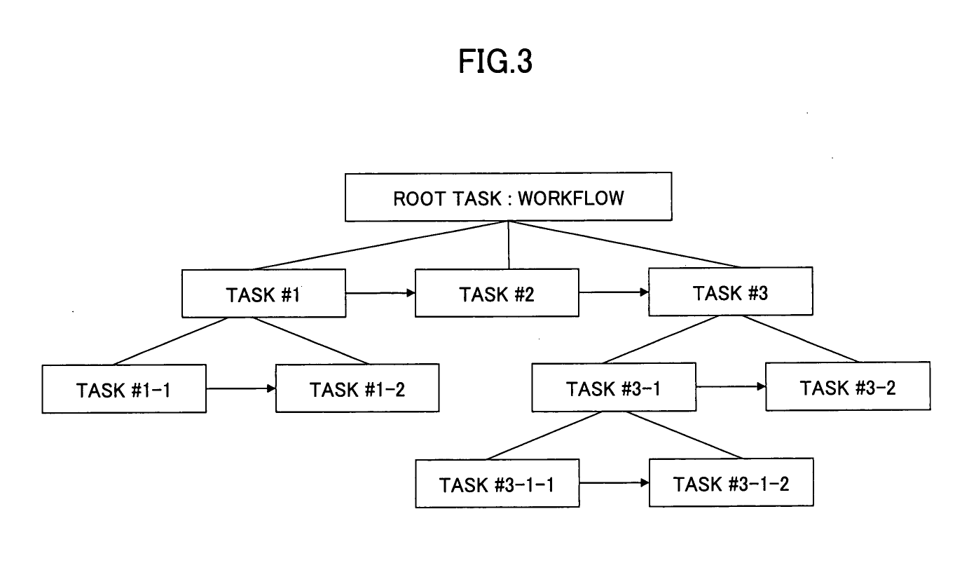

FIG. 3 is a diagram illustrating a configuration example of the workflow. In FIG. 3, a workflow (a project) being a root task is formed by one or more tasks (#1, #2, #3, . . . ). Each task further includes one or more subtasks (#1-1, #1-2, #3-1, #3-2, #3-1-1, #3-1-2, . . . ), and can be hierarchically formed. That is, one workflow has a plurality of tasks, and one task has a plurality of subtasks. Order relations (indicated by arrows in FIG. 3) are made in the same manner as a general workflow management system. Also, each task and each subtask may have the relevant information and relevant documents.

The task instance means a task as a substantial object individually managed. The task model or a process type means a substantial object as a model of a higher abstraction degree which is a model of the task instance.

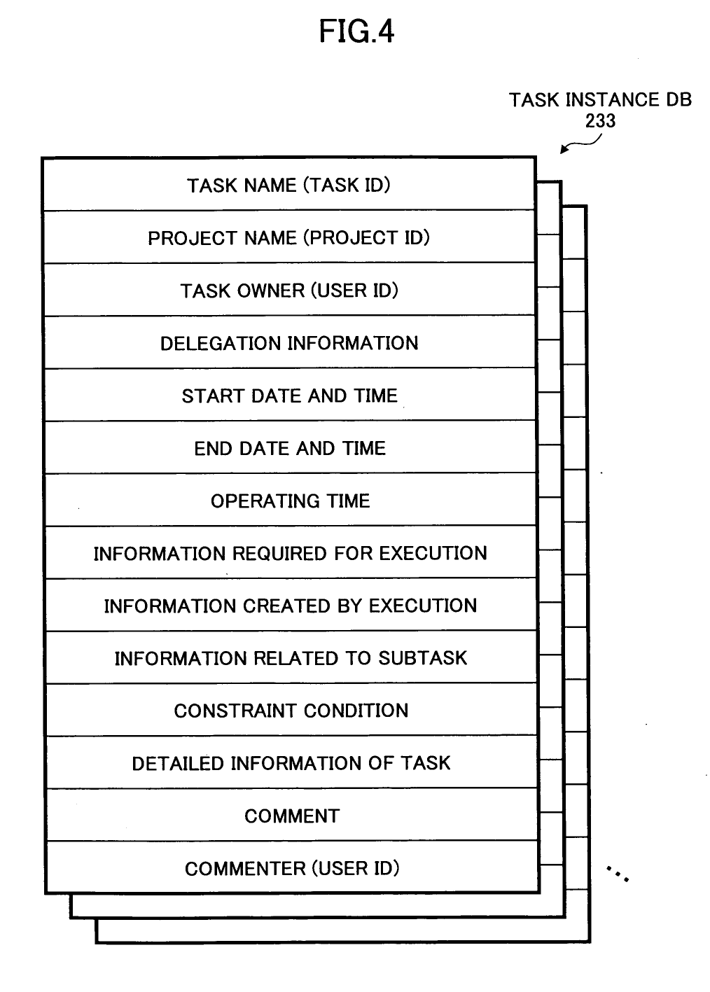

FIG. 4 is a diagram illustrating a data structure example of the task instance DB 233. The task instance DB 233 includes items of “TASK NAME (TASK ID)” specifying a task, “PROJECT NAME (PROJECT ID)” specifying a project to which the task belongs, “TASK OWNER (USER ID)” specifying an owner having an administrative authority of the task, and “DELEGATION INFORMATION” indicating a presence or an absence of a delegation of the task, a user name (user ID) to whom the task is delegated, and a like. When the task has not been delegated, a performer of the task (a task-executing user) is a task owner. When the task has been delegated, a user to whom the task is delegated becomes the task-executing user, and the task owner becomes a delegator.

The task instance DB 233 further includes items of “START DATE AND TIME” indicating a start date and time of the task, “END DATE AND TIME” indicating an end date and time of the task, “OPERATING TIME” indicating a time from a task start to a task end, “INFORMATION REQUIRED FOR EXECUTION” indicating a location of information required to execute the task, “INFORMATION CREATED BY EXECUTION” indicating a location of a document or a like created by executing the task, “INFORMATION RELATED TO SUBTASK” indicating the task ID of a subtask of the task, “CONSTRAINT CONDITION” indicating a condition to execute the task, “TASK DETAILED INFORMATION” describing contents of the task, “COMMENT” indicating contents of a comment added to the task, and “COMMENTER (USER ID)” specifying a user who made the comment.

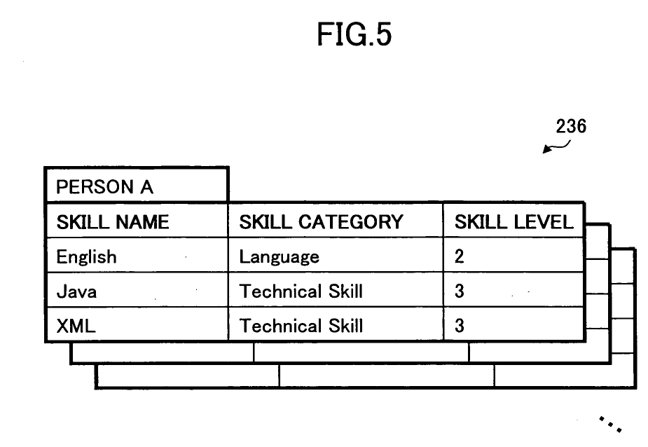

FIG. 5 is a diagram illustrating a data structure example of the skill information DB 236. The skill information DB 236 includes items of “SKILL NAME”, “SKILL CATEGORY”, and “SKILL LEVEL” for each user identified by “PERSON A” or a like. This data structure example illustrates a case in that a user “PERSON A” possesses a skill level “2” of a skill name “English” classified into a skill category “Language”, a skill level “3” of a skill name “Java” classified into a skill category “Technical Skill”, and a skill level “3” of a skill name “XML” classified into a skill category “Technical Skill”.

### <Operations>

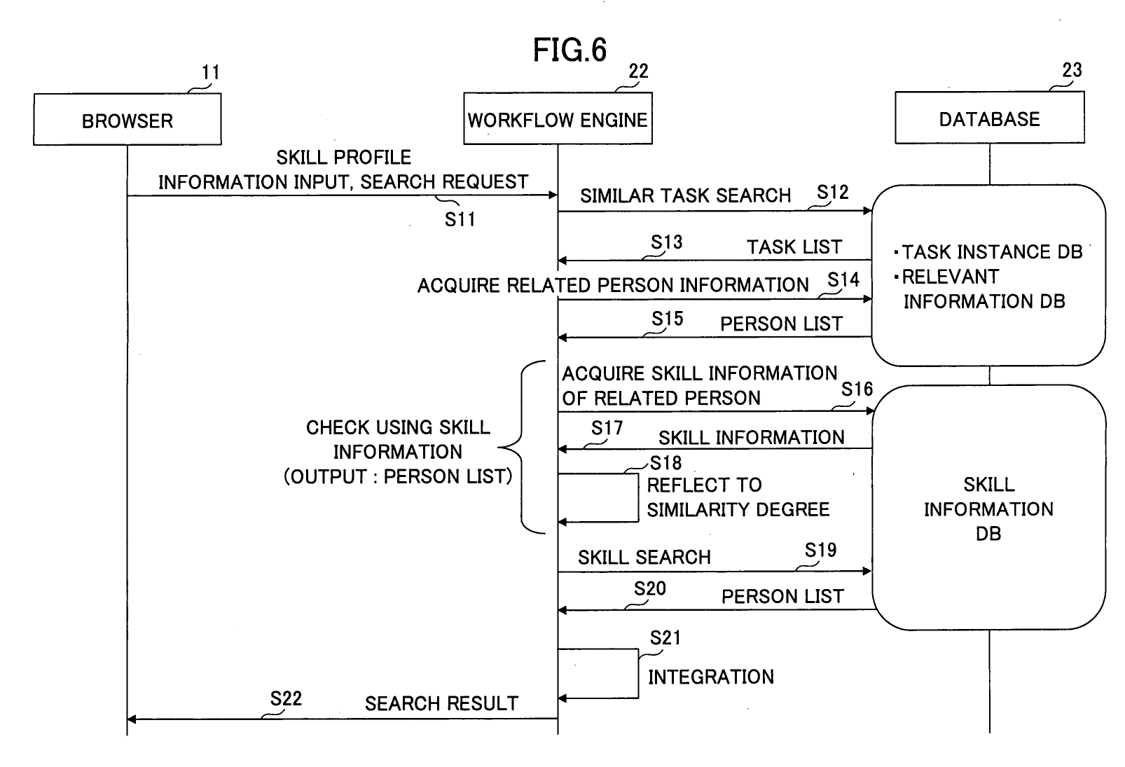

FIG. 6 is a sequence diagram illustrating a process example according to the embodiment.

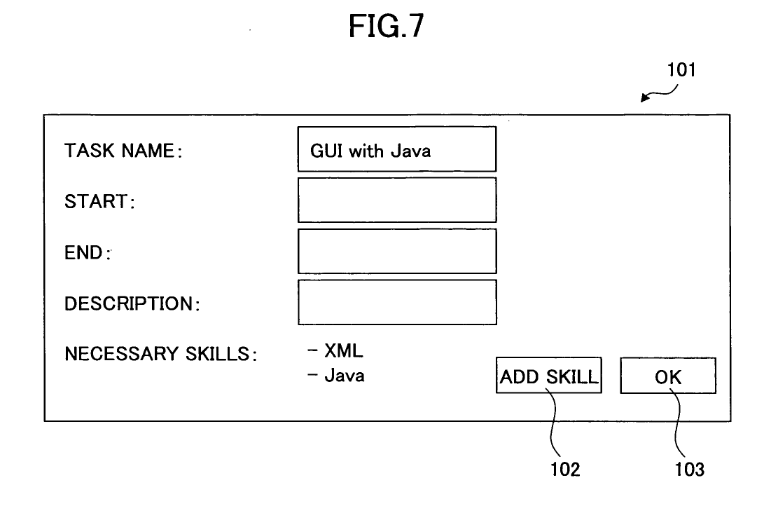

First, after the user U creates a new task or opens an existing task, the user U inputs skill profile information from the browser 11, and conducts a search request (step S11). FIG. 7 is a diagram illustrating an example of a search screen 101. The search screen 101 displays coresponding information from the task information in fields of “TASK NAME” specifying the task, “START” indicating the start date and time, “END” indicating the end date and time, and “DESCRIPTION” indicating detailed information. Also, if the user presses an “ADD SKILL” button 102 and selects one or more skill names from a selection list (not shown), the one or more skill names are input and displayed in a field of “NECESSARY SKILLS”. The one or more skill names are managed as skill profile information to specify respective skills. In a case in which the skill information DB 236 is structured in detail more than the data structure illustrated in FIG. 5, the skill profile information can be further in detail by inputting detailed information.

When the user U selects an “OK” button 103, a search request is conducted.

Referring back to FIG. 6, the skill consideration search part 227 of the workflow engine 22 uses the function of the search engine 221, and conducts a similar task search with respect to the task instance DB 233 and the relevant information DB 231 by using the task name and the detailed information of the task information as search keys (step S12) Then, the skill consideration search part 227 acquires a task list as a search result (step S13). The task list includes the task names and similarity degrees which correspond to the search.

Subsequently, the skill consideration search part 227 of the workflow engine 22 acquires related person information (the task-executing user, the commenter, the delegator, or the like) from the task information of each of tasks listed in the task list (step S14), and acquires the person list (step S15). The person list includes the person name, a role (indicating the task-executing user, the commenter, the delegator, or the like), the similarity degree (acquired from a similar task search), and the task name.

Next, the skill consideration search part 227 of the workflow engine 22 uses the function of the search engine 221 for each person based on the person names listed in the person list, and acquires the skill information (steps S16 and S17).

The skill consideration search part 227 of the workflow engine 22 determines whether or not the skill name indicated in the skill profile information is included in the skill information for each person, further determines the skill level if the skill name is included in the skill information, and reflects to the similarity degree of a corresponding person name in the person list (step S18).

Subsequently, the skill consideration search part 227 of the workflow engine 22 uses the function of the search engine 221, and conducts a skill search with respect to the skill information DB 236 by using the skill name of the skill profile information as a search key (step S19). Then, the skill consideration search part 227 acquires a person list as a search result (step S20). The person list includes the person name and a level average value.

After that, the skill consideration search part 227 of the workflow engine 22 integrates one person list modified in the step S18 and another person list acquired in the step S20, and calculates total ranking points based on a predetermined mathematical formula (step S21). Then, the skill consideration search part 227 presents a search result at the browser 11 through the GUI control part 21 (step S22).

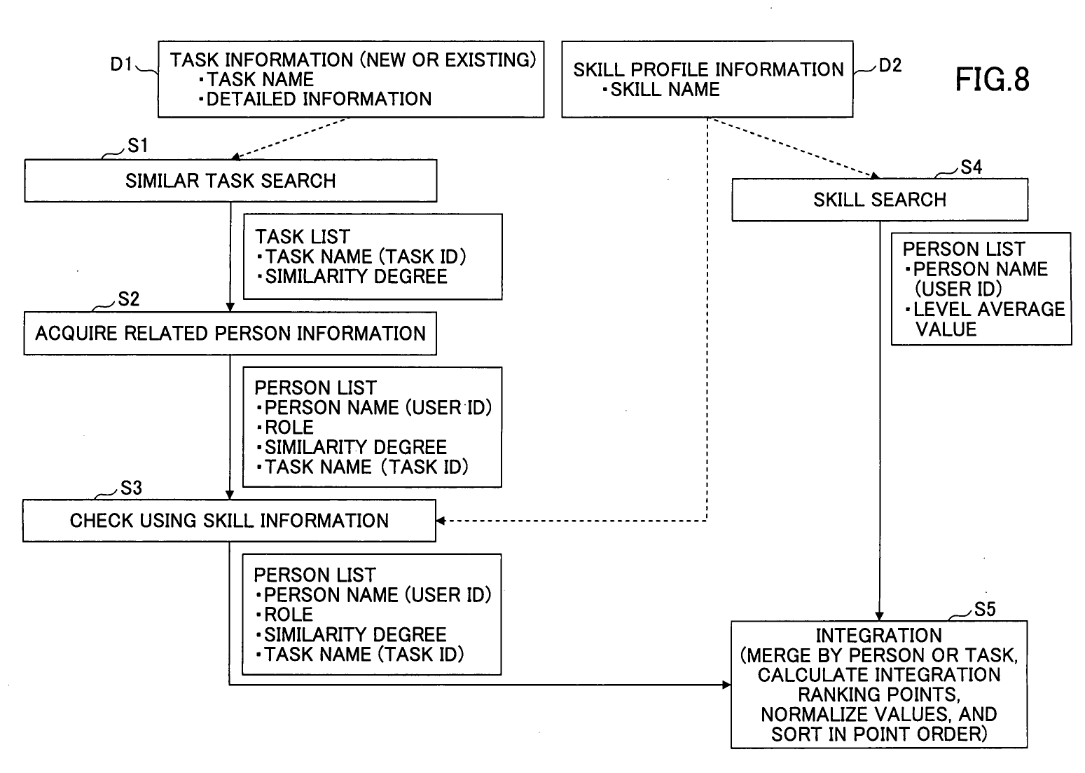

FIG. 8 is a diagram illustrating information (data) and a process flow when a search is conducted, according to the embodiment. Processes illustrated in FIG. 8 are conducted mainly by the skill consideration search part 227.

First, in a process of the similar task search (step S1), the similar task search is conducted with respect to the task instance DB 233, the relevant information DB 231, and the like, based on task information D1 such as the task name, the detailed information, and the like. The task information D1 is input when the new task is created, or is the task information of the existing task which is opened. As a process result, the task list including the task names (task IDs) and similarity degrees is output. The similarity degree is a value corresponding to a count, a ratio, or a place of finding a character string of the task information D1, which is used as a search key word. For example, the similarity degree is normalized so that an upper limitation (maximum value) is “100”.

Subsequently, in a process of an acquisition of the related person (step S2), based on the task list output in the process of the similar task search (step S1), the related person is acquired from the task information (FIG. 4) of each task listed in the task list, and the person list including the person name (user ID), the role, the similarity degree, and the task name (task ID) is output as a result. The task-executing user, the commenter, or the delegator is indicated as the related person, and the role indicates a type of the related person. The result of the similar task search is applied as the similarity degree. The task name is indicated by the task name of the task where information of the related person is retrieved.

After that, in a process of a check using the skill information (step S3), the skill information is acquired from the skill information DB 236 based on each of person names (user IDs) included in the person list output in the process of the acquisition of the related person (step S2), and it is made to adjust the similarity degree by determining whether or not the skill information corresponds to skill profile information D2 such as one or more skill names input by the user when the search request is made. As a process result, the person list including the person name (user ID), the role, the similarity degree, and the task name (task ID) is output. Contents of the person list output in the process of the acquisition of the related person (step S2) are applied, except for the similarity degree. Regarding the similarity degree, in a case of including the skill name of the skill profile information D2 in the skill information of a corresponding person name (user ID), values of skill levels are averaged and normalized (upper limitation “100”), and are further averaged by including the similarity degree of the similar task search which is applied at a prior step. Instead of simply averaging the values, a predetermined weight may be applied.

When there is no task found in the process of the similar task search (step S1) (when the task list is blank), the acquisition of the related person (step S2) and the check using the skill information (step S3) are not conducted.

On the other hand, in parallel with the above-described processes, in a process of the skill search (step S4), a search is conducted by using the skill information DB 236 as a search subject based on the skill profile information D2 such as one or more skill names and the like which are input by the user when the search request is made. As a process result, the person list including the person name (user ID) and a level average value is output. The level average value is an average value of the skill levels corresponding to the skill names which are found in the skill information DB 236, for each of the person names (user ID) in which the skill information for the person includes the skill name of the skill profile information D2. For example, the level average value is normalized so that the upper limitation (maximum value) is “100”.

Subsequently, in a process of an integration (step S5), the person list output in the process of the check using the skill information (step S3) is integrated with the person list output in the process of the skill search (step S4). That is, the integration is made by merging for each person name (user ID) in a case of requesting persons (experts) related to the task and the skill profile, or by merging for each task in a case of requesting tasks. Also, for each person or each task, the total ranking points are calculated by using the predetermined mathematic formula based on the role, the similarity degree, and the level average value, and is normalized (for example, the upper limitation is “100”). Then, the integration result is sorted in an order of the total ranking points.

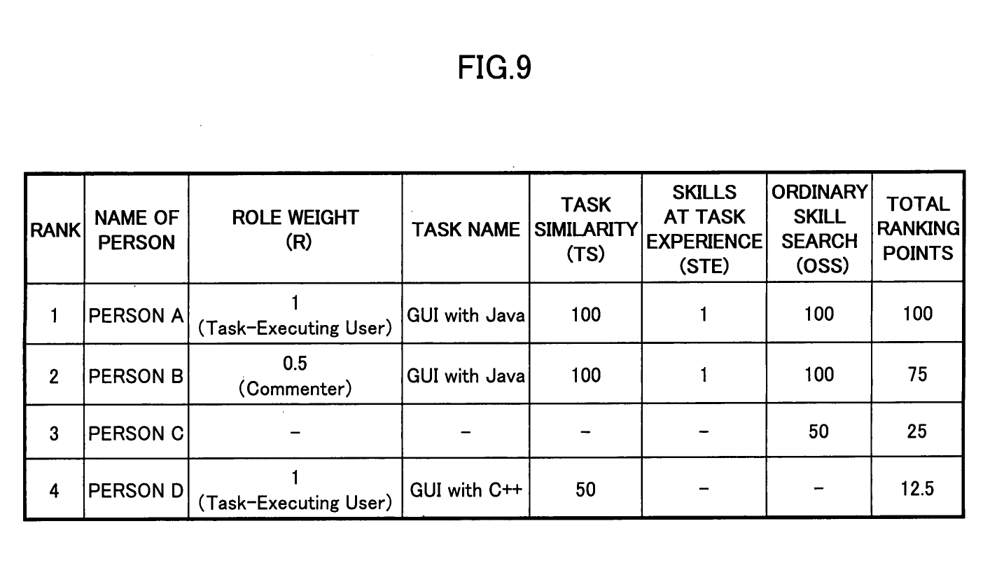

FIG. 9 is a diagram illustrating an example of the integration result. In FIG. 9, a result of merging for each person name (user ID) is illustrated as the integration result. From a left column, a “RANK” item indicates ranks from a top with respect to a result from sorting in the order of the total ranking points. A “NAME OF PERSON” item indicates person names merged from two person lists. A “ROLE WEIGHT (R)” item indicates “1” if the task-executing user and “0.5” if the commenter, and “0.5” if the delegator. Since the commenter and the delegator do not actually execute the task and do not actually use their own skills for the task, contribution to the total ranking points is reduced. It should be noted that it is not limited to values “1” and “0.5”, but the values may be appropriately varied through a system operation.

A “TASK NAME” item indicates one or more task names corresponding to the person name. A “TASK SIMILARITY (TS)” item indicates the similarity degree merged from the person list corresponding to the person name. A “SKILLS AT TASK EXPERIENCE (STE)” item indicates “1” if the person name is acquired by the similar task search and the skill search, and “0” if the person name is not acquired by the similar task search and the skill search. Accordingly, it is possible to prioritize the person names acquired from both two searches, as higher certainty. An “ORDINARY SKILL SEARCH (OSS)” item indicates a value resulted from merging the level average values acquired by the skill search.

A “TOTAL RANKING POINTS” item indicates a values calculated by using the above variable names in parenthesis as follows:

R×((0.25×TS)+STE×(0.25×OSS))+(0.5×OSS).

It should be noted that it is not limited to values “0.25” and “0.5” but the values may be appropriately varied through a system operation.

In FIG. 9, “PERSON A” and “PERSON B” have full scores for the “TASK SIMILARITY (TS)” item, the “SKILLS AT TASK EXPERIENCE (STE)” item, and the “ORDINARY SKILL SEARCH (OSS)” item. Regarding the “PERSON A”, since the “PERSON A” is the task-executing user, the “ROLE WEIGHT (R)” item indicates “1”. Regarding the “PERSON B”, since the “PERSON B” is the commenter, the “ROLE WEIGHT (R)” item indicates “0.5”. Accordingly, there is a difference between values “100” and “75” of the total ranking points, and the “PERSON A” positions at a higher rank. Since “PERSON C” is acquired as the person name by the skill search alone and “PERSON D” is acquired as the person name by the similar task search alone, the total ranking points for the “PERSON C” and the “PERSON D” are rather lower. Moreover, a value “50” of the “ORDINARY SKILL SEARCH (OSS)” item for “PERSON C” is the same score as a value “50” of the “TASK SIMILARITY (TS)” item for “PERSON D”. However, since a coefficient of the “ORDINARY SKILL SEARCH (OSS)” item is greater than that of the “TASK SIMILARITY (TS)” item, the “PERSON C” ranks higher than the “PERSON D”.

A display of the search result for the user U may include all information illustrated in FIG. 9. Alternatively, values of the “RANK” item, the “NAME OF PERSON” item, the “TASK NAME” item, and the “TOTAL RANKING POINTS” item may be sufficient to display. In this case, in order to make an access to information of a desired person or task, the person name and the task may be formatted in a hotlink. It is possible to display detailed information by clicking the person name or the task name with a mouse. It is further possible to automatically open a transmission form of an e-mail directing to a person identified by the person name if the person name is clicked.

In the workflow management system according to the embodiment, it is possible to easily search for and present proper human resources and tasks by effectively using the skill information in a process of searches.

The present invention is not limited to the specifically disclosed embodiments, and variations and modifications may be made without departing from the scope of the invention.

The present application is based on the Japanese Priority Patent Application No. 2008-070375 filed Mar. 18, 2008, the entire contents of which are hereby incorporated by reference.

What is claimed is:

1. A workflow management system for dynamically structuring a workflow model when executing a workflow, comprising:
a task information acquisition part configured to acquire task information including at least a task name and detailed information from a working task when a search request of a human resource or a task is made;
a skill profile information input part configured to input skill profile information including at least a skill name when the search request is made;
a similar task search part configured to search for a similar existing task based on the task information;
a related person acquisition part configured to acquire related person information of a task searched by the similar task search part;
a check part configured to check a consistency with the skill profile information with respect to the related person information searched by the related person acquisition part;
a skill search part configured to search for the human resource having the skill indicated in the skill profile information; and
an integration part configured to calculate ranking points for each human resource or each task based on outputs of the check part and the skill search part, and to present the ranking point prioritized by higher points.

2. A workflow management method conducted in a workflow management system for dynamically structuring a workflow model when executing a workflow, said method comprising the steps of:
acquiring task information including at least a task name and detailed information from a working task when a search request of a human resource or a task is made;
inputting skill profile information including at least a skill name when the search request is made;
searching for a similar existing task based on the task information;
acquiring related person information of a task searched in searching for the similar existing task;
checking a consistency with the skill profile information with respect to the related person information searched in acquiring the related person information;
searching for the human resource having the skill indicated in the skill profile information; and
calculating ranking points for each human resource or each task based on outputs of checking the consistency and searching for the human resource having the skill, and to present the ranking points prioritized by higher points.

3. A program product for causing a computer to function as a workflow management system for dynamically structuring a workflow model when executing a workflow, comprising the codes for:
acquiring task information including at least a task name and detailed information from a working task when a search request of a human resource or a task is made;
inputting skill profile information including at least a skill name when the search request is made;
searching for a similar existing task based on the task information;
acquiring related person information of a task searched in searching for the similar existing task;
checking a consistency with the skill profile information with respect to the related person information searched in acquiring the related person information;
searching for the human resource having the skill indicated in the skill profile information; and
calculating ranking points for each human resource or each task based on outputs of checking the consistency and searching for the human resource having the skill, and to present the ranking points prioritized with higher points.
